(19) United States
(12) Patent Application Publication
(10) Pub. No.: US 2018/0272438 A1
(43) Pub. Date: Sep. 27, 2018

(54) Microstop Setting Station

(71) Applicant: Leroy K. Leo, Wichita, KS (US)

(72) Inventor: Leroy K. Leo, Wichita, KS (US)

(21) Appl. No.: 15/989,753

(22) Filed: May 25, 2018

(51) Int. Cl. B23B 49/00

(52) U.S. Cl. CPC B23B 49/008

(57) ABSTRACT

An assembly for translating extensions of a microstop's bit to other microstop bits, wherein the microstop has a shank, a first platen, and bit cutting end which is alternatively extendable from and retractable toward the first platen, the assembly incorporating a frame; a second platen having a port which is fitted for through extensions of the bit cutting end; a contact member; a spring biased slide shaft for positioning the contact member beneath the port at a first position, the slide shaft being adapted for, upon an extension of the bit cutting end from the first platen, engaging the contact member and moving the contact member to a second position; the assembly further incorporating a linear encoder mounted to the frame for measuring displacements of the contact member between the first and second positions.

### FIELD OF THE INVENTION

This invention relates to precision microstop countersink and counterbore drilling tools. More particularly, this invention relates to apparatus and assemblies which are adapted for assisting in setting the drilling depths of such tools.

### BACKGROUND OF THE INVENTION

Microstop countersink and counterbore drilling tools are commonly capable of drilling tiered fastener receiving channels which include a cylindrical shaft receiving section having an inside diameter closely matching the outside diameter of the shaft portion of a fastener (either a screw or a rivet) which is to be received within the fastener channel. Such microstop drilled tiered channels typically further include a concentric fastener head receiving portion closely matching the positive profile, shape, and size of the head of such fastener. In a properly formed fastener countersink, the head receiving portion of channel closely nestingly receives the head of such fastener.

Where, for example, the fastener has a 100° conical head having an 187/1000″ axial height, a microstop countersink tool which serves such fastener may, in a matching fashion, axially extend and retract a bit having a 100° countersink cutting end. Such microstop typically may be adjusted so that the 100° conical bore cutting tier of its bit may extend from a lower platen or bearing surface of the microstop only 187/1000″. After such setting of the microstop, it may be used to accurately drill hundreds of countersink fastener channels, each of which closely and accurately receives one of such conical headed fasteners.

While microstop drilling tools may advantageously accurately repeatedly drill a desired countersink channel (such as the above exemplary 187/1000″ 100° countersink channel), microstops are typically subject to becoming erroneously set or adjusted to drill the countersink portions of fastener receiving channels either too deep or too shallow. In the above example which requires a 187/1000″ countersink, an erroneous setting of the microstop to stop the extension of the distal or lower end of the conical portion of the cutting bit at 185/1000″ from the bearing platen will undesirably produce a fastener channel which causes the head of a received fastener to protrude 2/1000″ from a finished surface. Alternatively, an oppositely erroneous 189/1000″ setting of the microstop will undesirably produce a 2/1000″ depression within such finished surface. Where the finished surface is, for example, an outer surface of an aircraft wing, such erroneous small protrusions and indentations at the sites of fastener heads upon the wing may be deemed unacceptable due to induced micro-eddy air currents which may interfere with the lift function of the wing.

A known method for avoiding the above described microstop setting inaccuracies includes utilizing a microstop to drill a series of test bores, and applying a surface bearing micrometer depth/protrusion gauge to fasteners received within such test bores. Where such micrometer gauge reads substantially zero inches of protrusion or depression at the site of a fastener head installed within one of such test bores, a microstop setting which has been noted as having cut such one bore may be deemed correct. While the microstop maintains such extension setting which has been verified as correct, it may be repeatedly utilized for accurately drilling numerous successive countersink channels.

A problem associated with the above described test bore measuring method of adjusting and setting of microstops is that the method is labor intensive and time consuming, and must be repeated every time the tiered cutting end of a microstop's bit is sharpened. Where multiple microstops are utilized by workers in an airplane manufacturing process, the above described tedious and labor intensive method for microstop setting is correspondingly multiplied and exacerbated, wasting a significant portion of the productivity potential of the manufacturing workforce.

The instant inventive assembly for translating an extension of a first microstop countersink bit to second microstop countersink bit extensions solves or ameliorates the microstop setting problems described above by providing apparatus and machinery in the form of a microstop setting station which is capable of correctly setting numerous microstops based upon a bit extension of a single microstop which has been verified as correctly set.

### BRIEF SUMMARY OF THE INVENTION

The instant inventive assembly is intended to serve as a microstop setting station which performs a function of efficiently correctly setting multiple countersink or counterbore cutting microstop tools. In their associations with the inventive assembly, microstop tools themselves constitute both gauging tools for preliminarily setting and calibration of the inventive assembly and work pieces upon which the inventive assembly operates.

The gauging and workpiece functioning microstops of the invention are typically of the type which are adapted to move the tiered cutting end of a countersink or counterbore drill bit to a precisely gauged extension beyond the microstop's lower platen or bearing surface. Such microstops commonly include an internal screw adjustable bit extension stop and circumferential rotary position locking teeth, an example of such microstop appearing in U.S. Pat. No. 2,409,377 entitled “Micrometer Stop Countersink” issued Oct. 15, 1946, to Miller. Where, for example, a microstop has fifty circumferential teeth, and has twenty travel stop adjusting screw threads per inch, each toothed increment of the microstop represents a 1/1000″ increase or decrease of the maximum extension of the cutting end of the microstop's bit beyond the microstop's platen bearing surface. Accordingly, countersink drilling microstops are commonly capable of accurately setting countersink fastener head depths at 1/1000″ increments. The instant inventive assembly initially deploys and utilizes such a microstop as an assembly setting gauge, provided that the microstop is preliminarily correctly set to tolerance of 1/1000″ at a desired countersink cutting depth.

A first structural component of the instant inventive assembly comprises a frame which is preferably rigid and has a microstop attachment end. In a preferred embodiment, the microstop attachment end of the frame corresponds with the vertically upward direction, causing the inventive station to be conveniently used by a standing operator of the assembly. Suitably, the microstop attachment end of the inventive station may be alternatively downwardly positioned. Laterally positioned microstop attachment ends are relatively undesirable due to possible gravity induced deflections of microstops which are held and reciprocatingly moved by the assembly. In a preferred embodiment, the frame component comprises a box frame, including an upper table top configured level which is supported by a peripheral series of rigid columns.

Where the microstops associated with the invention include, as is preferred, a lower bearing surface or land, such structure constitutes a first platen relative to the invention's corresponding bearing surfaces. In ordinary use, such first platen microstop component bears against the surface of the item to be drilled, such as the skin of an aircraft's wing. The instant inventive assembly preferably comprises a second platen element which is supported and preferably rigidly positioned at the frame's microstop attachment end. The second platen may suitably comprise an aperture within the preferred table top configured plate element of the frame, such aperture preferably functioning as microstop bit cutting end receiving port. In the preferred embodiment, such port has a diameter which is both large enough to allow for vertical through passages of the cutting end of a microstop's bit and is small enough to allow the microstop's first platen to bear against the assembly's second platen at the periphery of the port.

In order to allow the assembly to accommodate microstops having varying platen diameters and varying bit diameters, the instant invention's second platen component preferably further comprises at least a first removable and interchangeable cover plate, such plate having port which varies in size in relation to a differently sized microstop to be served by the inventive assembly. Where such size accommodating cover plates are provided, the port within the underlying table top plate is preferably large enough to accommodate a largest microstop and largest bit which may be served by the inventive station.

A further structural component of the instant inventive assembly comprises an inelastic or rigid contact member which is preferably adapted for impinging against the countersink cutting or counterbore cutting portion of a bit of a microstop which is installed within or used upon the inventive assembly. In the preferred embodiment, the point of contact or impingement of the contact member with such bit comprises an upwardly opening tiered socket whose negative profile closely matches the cutting profile of the cutting end of the microstop's bit. Where such bit is intended to cut a conical countersink, the negative profile contact tier of the socket is, correspondingly, preferably conical. Alternatively, where the bit is adapted to cut a cylindrical counterbore, such contact point preferably comprises a ring shaped floor or annular land which matches the positive profile of such counterboring bit.

To facilitate different microstops having differently sized and shaped bits, the invention's contact member is preferably segmented to include multiple interchangeable upper contact point halves, each interchangeable contact point half having a socket which is specially fitted for receiving the bit of a particular microstop.

Further structural components of the instant inventive assembly comprise means for initially positioning the contact member at a first position, such position preferably being within or immediately beneath, and being concentrically aligned with the second platen's port. In the preferred embodiment, the positioning means are adapted for, upon an extension of the cutting end of the microstop's bit from the microstop's first platen bearing surface, engaging such bit end against the annular bevel or land of the contact member's socket. Such adaptation preferably permits and guides subsequent linear movement of the contact member to a second position which underlies the first position. In operation of the invention, such subsequent linear movement matched the microstop's bit extension.

In a preferred embodiment, the invention's positioning means comprise a spring biased retractable and extendable support column which is mounted to the frame, and which holds and normally upwardly positions the contact member at its first position. Other commonly known and configured mechanisms capable of holding of a contact member and facilitating two position motion of such member are considered to fall within the scope of the invention. For example, a slide track mounted contact member would fall within the scope of the invention. Also, an elastically mounted contact member or a pivot arm mounted contact member would fall within the scope of the invention.

A further preferred structural component of the instant inventive assembly comprises means for holding and for alternatively axially (along an axis pointing toward the contact member) extending and retracting the microstop. In a preferred embodiment, such means for holding may comprise a common drill chuck which may clamp and hold the upper shank portion of a microstop and which is slidably mounted upon a columnar movement guide, such holding means assembly suitably being mounting to an upper surface of the assembly's upper table top plate. In the preferred embodiment the holding means may comprise a linear motion actuator such as a jack screw actuator which moves the drill chuck and a microstop held by the drill chuck alternatively toward and away from the invention's contact member. Other commonly known linear motion actuators may be utilized for reciprocatingly moving or guiding movement of the microstop. For example, a handle for manually driving a microstop holding slide guide mounted member may be provided. Pneumatic cylinder actuators, hydraulic cylinder actuators, electric solenoid actuators, and motor driven jack screw actuators may also be suitably utilized as components of the invention's moving means.

A further structural component of the instant inventive assembly comprises means for measuring, and preferably displaying a measurement of, a displacement of the contact member from the first position to the second position. In the preferred embodiment, such means is connected operatively to the contact member, such means preferably comprising a linear encoder of the optical, magnetic, capacitive, inductive, or eddy current type. Where such linear encoder component is provided as the invention's measuring means, the linear encoder preferably comprises scale and sensor which are movable in relation to each other. In the preferred embodiment, either the scale or the sensor is fixedly and rigidly attached to the invention's contact member while the other component of the linear encoder is rigidly and immovably mounted upon the frame or with respect to the frame.

Other means for measuring which may be suitably utilized may comprise a combination of a micrometer having a pair of surface contacts in combination with an incorporation within the assembly of corresponding relatively movable surface contacts which are presented upon or attached to both the frame and the contact member. Where, as is preferred, the invention's means for measuring comprises a linear encoder, a digital display is preferably additionally provided for ease of use of and ease of setting of the encoder.

In use of the instant assembly, and assuming provisions of the preferred components described above, an operator may be initially provided with a microstop having a predetermined accurate and correct drilling depth setting. Such preset microstop may be initially mounted within the assembly's overlying microstop shank clamping chuck. Thereafter, the invention's linear motion actuator may be operated to move the chuck and attached microstop downwardly until the microstop's first platen presses against the bearing surface of the invention's second platen, preferably at the periphery of such second platen's bit passage port.

Further actuation of the linear motion actuator moves the microstop's bit within the microstop's body in the direction of the invention's contact member until such motion is stopped by microstop's precalibrated drilling depth setting. Upon completion of such calibrated drilling depth motion, the invention's contact member correspondingly displaces to its second position a distance which is substantially the same as the microstop's preset cutting depth. Such contact member displacement is advantageously reflected as a position reading upon the linear encoder's digital readout, and such position reading may be noted by an operator for future reference.

In a preferred embodiment, the linear encoder is of the type which allows such measured reading to be set as a zero level which is retained in the encoder's microprocessor memory. Upon noting such contact member displacement reading, or upon setting such reading as a zero level, the instant inventive assembly is effectively calibrated for use for subsequently correctly setting the cutting depth of other microstops having similar cutting bits.

Such other microstops may be successively attached to the chuck, and may in a similar fashion be downwardly driven against the assembly's contact member to produce a depth reading which is displayed as being either above or below the zero level. Incremental extensions and retractions of the drilling depth of such subsequently attached microstop may quickly and conveniently actuated within such subsequent microstop to reflect the setting of the master microstop within a tolerance of approximately 1/1000″. In use of the instant inventive microstop setting station, multiple microstops may be correctly set in a manner saving both labor and time.

Accordingly, objects of the instant invention include the provision of a microstop setting station which incorporates structures as described above, and which arranges those structures in manners described above for the achievement of the functions and benefits described above.

Other and further objects, benefits, and advantages of the instant invention will become known to those skilled in the art upon review of the Detailed Description which follows, and upon review of the appended drawings.

### BRIEF DESCRIPTION OF THE DRAWINGS

FIG. 1 is a perspective view of a preferred embodiment of the instant inventive assembly for translating an extension of a first microstop countersink bit to second microstop countersink bit extensions.

FIG. 2 is a sectional view as indicated in FIG. 1.

FIG. 3 is a magnified partial view of the structure of FIG. 2, as indicated in FIG. 2.

FIG. 4 redepicts the structure of FIG. 2, the view of FIG. 4 showing the assembly's contact member moved to a second position.

FIG. 5 is a magnified view of a portion of the structure of FIG. 4 as indicated in FIG. 4.

FIG. 6 is an alternative configuration of the structure of FIG. 1.

FIG. 7 is an alternative configuration of the structure of FIG. 2.

FIG. 8 is a perspective view of a contact member half of a contact member component of the structure depicted in FIG. 1.

FIG. 9 presents an alternative configuration of the structure of FIG. 8.

FIG. 10 presents a further alternative configuration of the structure of FIG. 8.

### DETAILED DESCRIPTION OF PREFERRED EMBODIMENTS

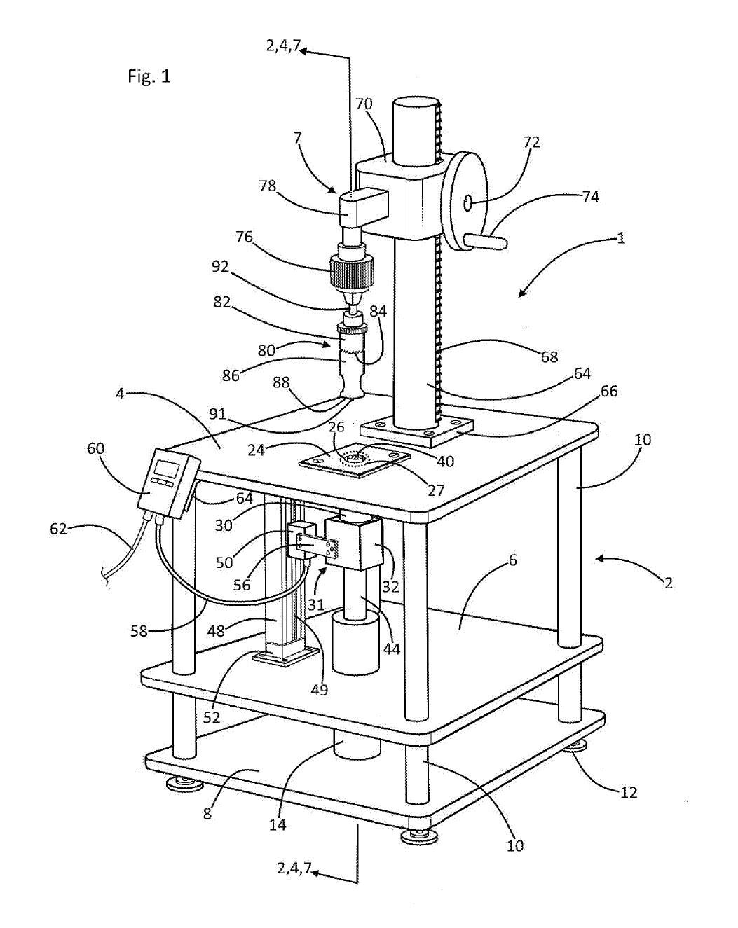

Referring now to the drawings and in particular to Drawing FIGS. 1-5, a preferred embodiment of the instant inventive assembly for translating an extension of a first microstop countersink bit to second microstop countersink bit extensions is referred to generally by Reference Arrow 1. The assembly 1 serves as a microstop setting station, and preferably comprises a rigid frame which is referred to generally by Reference Arrow 2. The frame 2 has a microstop attachment end which is, according to the view of FIG. 1, preferably positioned at the upper end of the frame 2. The microstop attachment end of the frame 2 preferably comprises an upper table top configured plate 4, an intermediate plate 6, a lower plate 8, and peripheral rigid support columns 10. In the preferred embodiment, adjustable feet 12 are provided for leveling of the setting station upon uneven surfaces.

A countersink or counterbore drilling microstop 80 is preferably of the type having an upper shank 92 (which may be held and clamped by a common drill chuck 76), a lower drill bit cutting end 90,91, upper and lower case halves 82 and 86 which are counter-turnable in relation to each other, and incremental depth adjusting teeth 84. In a common configuration of such microstop 80, a fractional turn along an angular distance represented by a single tooth among teeth 84 effectively imposes a 1/1000″ adjustment of the maximum extension of the drill bit's cutting end beyond the microstop's platen or bearing surface 88.

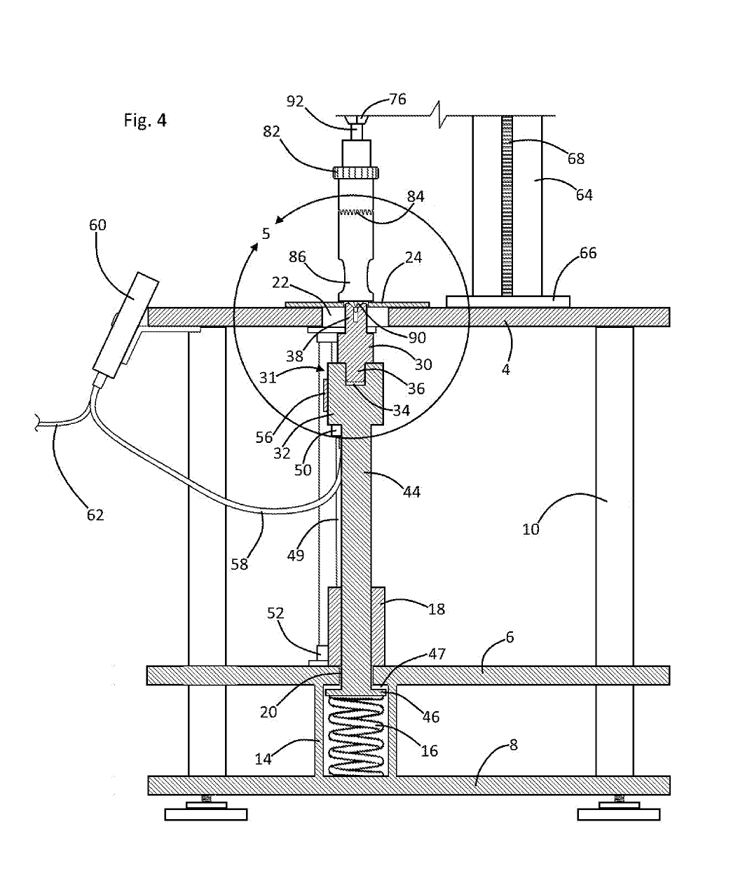

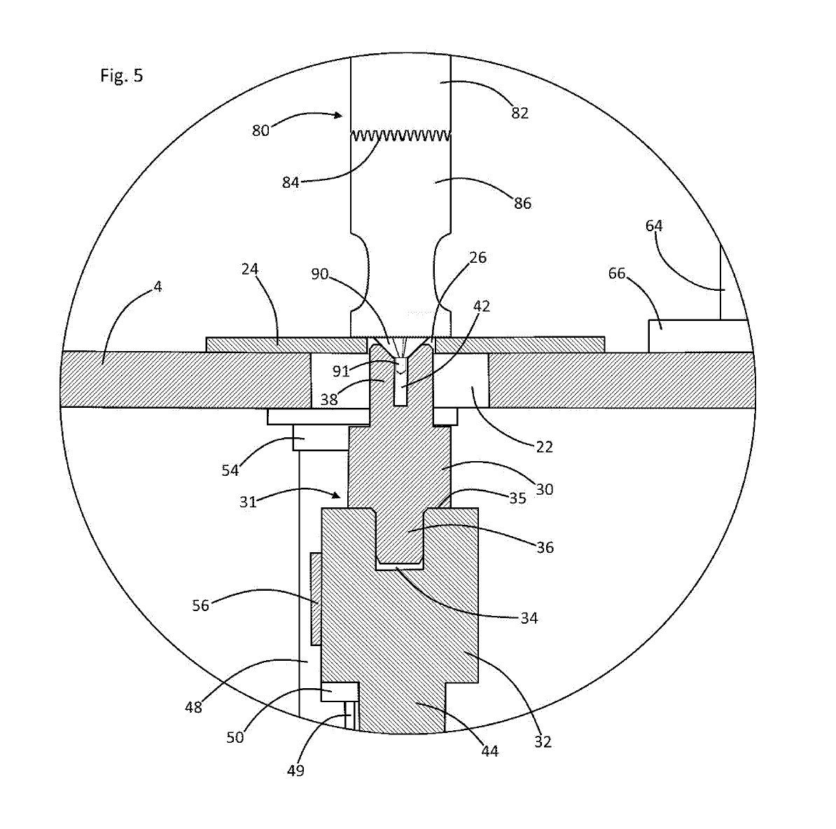

Upon designating such lower bearing surface 88 of the microstop 80 as a first platen, the instant inventive assembly comprises a second platen which may suitably comprise an upper surface of plate 4. Notwithstanding, in the preferred embodiment, the instant invention's platen component preferably comprises a stacked combination of plate 4 and an overlying interchangeable plate 24. Plate 24 has an aperture or port 26 which is concentrically aligned with an underlying port 22 of plate 4, the diameter of such port 26 being sized so that, referring further simultaneously to FIGS. 4 and 5, the first platen 88 may bear against the second platen 24,4 at the periphery of aperture 26, while allowing downward passage of the cutting end of the drill bit end 90,91 through port 26. The dashed elliptical line 27 drawn about port 26 in FIG. 1 is representative of differently configured plates 24 which may accommodate differently sized microstops having varying cutting bit diameters.

A further structural component of the instant inventive assembly comprises a contact member which is referred to generally by Reference Arrow 31. In the preferred embodiment, such contact member 31 is segmented to include an upper microstop contact half 30, and a lower or opposite half 32. In the preferred embodiment, such halves 30 and 32 of the contact member 31 are divided by a seam 35, and are interchangeably connected at such seam 35 by means of a pin and socket joint 36,34. Such seam 35 and pin and socket joint 36,34 is intended to be representative of other commonly known joints, such as screw connections, which may allow upper and lower halves of such structures to be alternatively connected and disconnected.

Where the cutting end of the extendable and retractable bit of a microstop 80 has a lower bit centering section 91 and has an overlying countersink drilling tier 90, the upward extension 38 of contact member half 30 is preferably configured to present an upwardly opening socket 40,42 whose walls form a closely fitted negative profile which may nestingly receive the positive profile 90,91 of such bit cutting end. Such negative profile matching character of the contact member 31 advantageously assures that, upon a downward motion of the microstop 80 in axial alignment with the contact member 31, the radially central and lower drilling centering portion 91 of the bit may enter the fastener shaft reflecting portion 42 of the socket without any undesirable contact or impingement against the contact member 31. Thereafter, upon further downward motion of such bit, the conical countersink cutting portion 90 comes into contact with the matching annular and conical floor 40 of such socket.

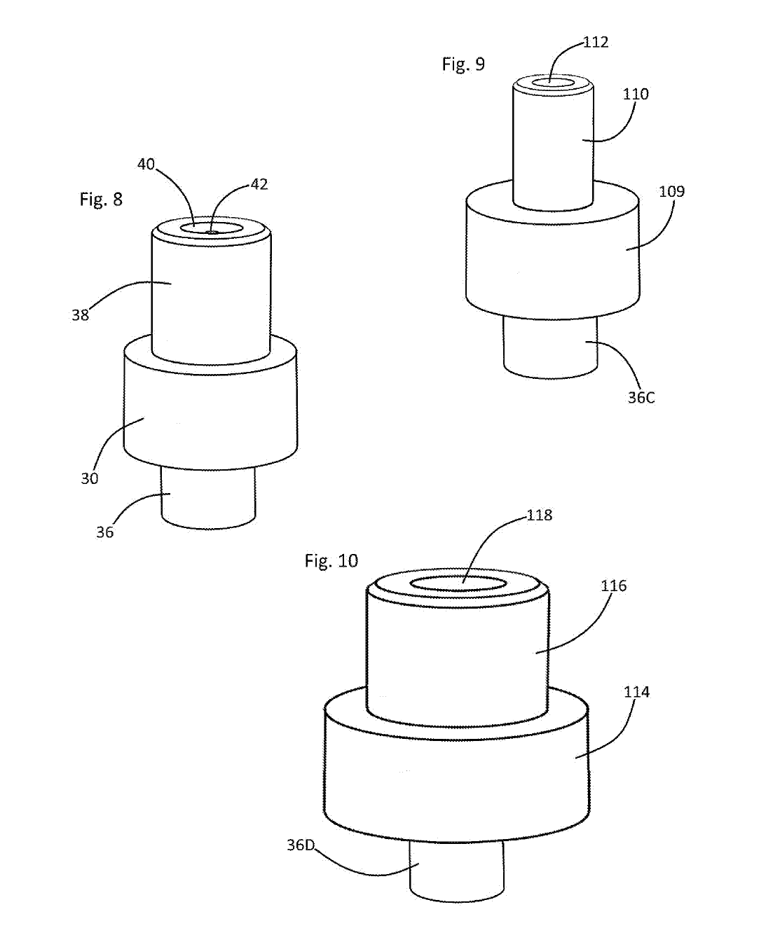

Referring further simultaneously to FIGS. 8, 9, and 10, alternative upper contact member halves 109 and 114 may be interchanged with the half 30 of Drawing FIGS. 1-5. The countersink socket 112 at the upper end of extension 110 of alternative half 109 may facilitate utilization of the instant inventive assembly with a different microstop having a smaller countersinking bit. Alternatively, socket 118 exposed at the upper end of extension 116 of half 114 would facilitate a microstop having a larger countersinking bit. In accordance with the instant invention, the interchangeable contact member upper halves represented by halves 30, 109, and 114 preferably have vertical dimensions identical to each other, and have identical attachment pins 36, 36C, or 36D. Through the provision of a series of alternative upper contact member halves, as represented by halves 30, 109, and 114, the instant inventive microstop setting station may be utilized upon a wide spectrum of differently sized microstops which cut multiple types and shapes of countersinks and counterbores.

Referring to FIGS. 1-3, it may be seen that the upper end of contact member 31 resides at a location at or near aperture 26 within plate 24. In use of the inventive station, such upward positioning of the contact member 31 constitutes a first or normal position, and in the preferred embodiment, means are preferably provided for normally positioning or biasing the contact member 31 toward such first position. In a preferred embodiment, such positioning means comprise a slide shaft 44 which is fixedly attached to and extends downwardly from the lower half 32 of the contact member 31. Such slide shaft 44 is preferably slidably received and guided by a slide sleeve 18 which is fixedly attached to intermediate plate 6 and which concentrically overlies a shaft passage aperture 20. A slide stop 46 is fixedly attached to the lower end of the slide shaft 44, and a spring 16 biases between stop 46 and the upper surface of the lower plate 8, such spring being mounted within a spring housing 14. While the spring 18 upwardly biases slide stop 46 against the lower surface of plate 6, slide shaft 44 and the attached contact member 31 are correspondingly normally held at their first positions.

Referring in particular to FIG. 1, overlying means for holding and moving the microstop 80 are also preferably provided, such means being referred to Reference Arrow 7. Such means, as depicted, may comprise a slide shaft 64 which is fixedly mounted to the upper surface of plate 4 by means of a screw attached mounting plate 66. A vertically movable slide sleeve 70 is mounted over the slide shaft 64, such sleeve 70 housing a screw actuator assembly (not depicted within views) which includes a gear turnable via axle 72 and turn crank 74. Such gear engages a vertically extending rack gear 68 which, upon turning and counter-turning of crank 74, alternatively raises and lowers the sleeve 70 along the slide shaft 64.

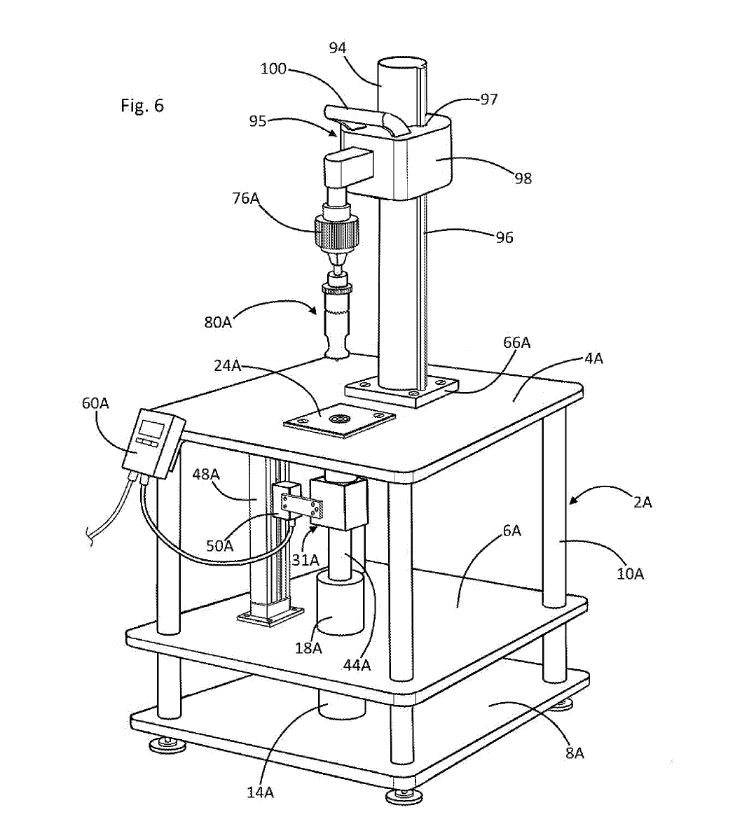

The sleeve and shaft assembly 70,64 including its vertical drive assembly 72,74,68 is intended as being representative of other commonly known linear motion actuators which may be suitably utilized for alternatively raising and lowering an attached microstop 80. For example, referring to the alternative configuration of FIG. 6, all reference numerals having the suffix “A” identify structures substantially identical to similarly numbered structures appearing in FIG. 1. In FIG. 6, the alternative microstop moving means is represented by Reference Arrow 95 includes a linear motion actuator which comprises a frictional slide sleeve 98 mounted over a slide shaft 94 and which is guided in alignment with contact member 31A by a ridge and channel combination 98,97. In the FIG. 6 alternative, an operator grasping handle 100 may alternatively downwardly drive handle 100 and upwardly pull thereon to downwardly and upwardly move the sleeve 98 along with the microstop attachment structures connected thereto.

The moving means 7 and 95 of FIGS. 1 and 6 are intended as being representative of other commonly known linear motion actuating and guiding assemblies which may facilitate motions of structures such as a microstop 80,80A between upper positions as depicted in FIGS. 1 and 6 and lowered positions as depicted in FIGS. 4 and 5.

Referring again to FIGS. 1-5, a rigid arm 78 attached to sleeve 70 supports a common drill chuck 76 which engages and clamps the shank 92 of the microstop 80. In operation, clockwise turning of crank 74 engages the rack gear 68 and downwardly moves sleeve 70 along the slide shaft 64. Such motion drives arm 78, chuck 76, and the attached microstop 80 downwardly until the lower cutting end 90,91 of the microstop's drill bit enters socket 40,42. Further downwardly driven motion of the microstop 80 causes the microstop's platen 88 to bear against the upper surface of plate 24, and causes the conical portion 90 of the microstop's bit to bear against the conical cutting portion 40 of the contact member's socket. Further downward driving motion simultaneously moves the bit and the contact member 31 downwardly until the motion of the bit is internally stopped within the microstop 80 at the microstop's closely calibrated maximum drilling depth. When the microstop's bit is so downwardly driven, the inventive assembly's contact member 31 advantageously correspondingly moves downwardly to its second position.

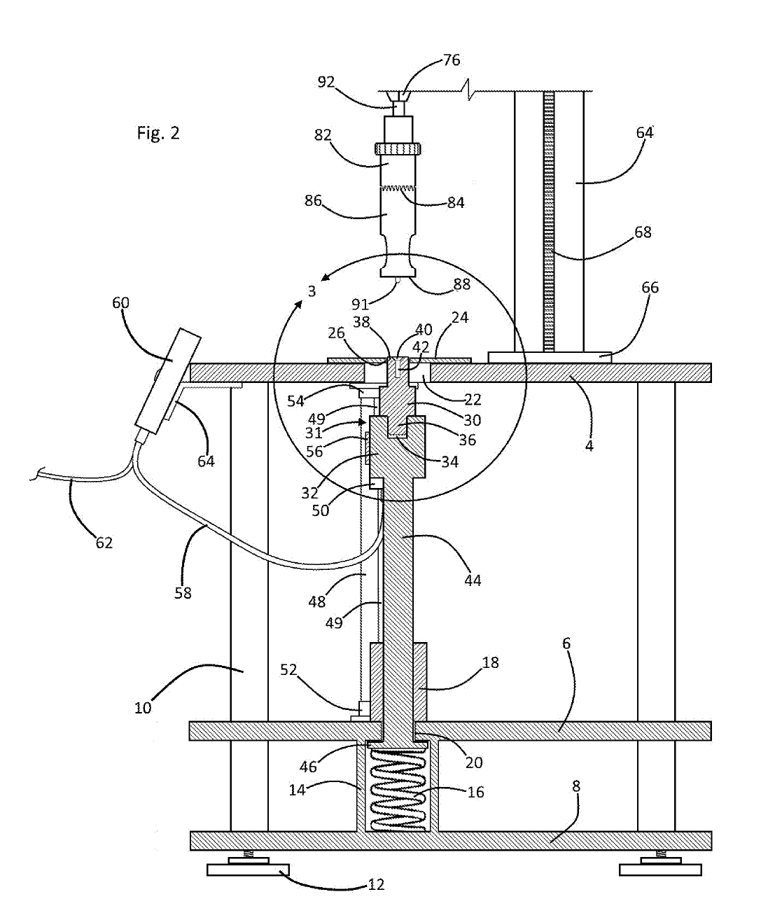

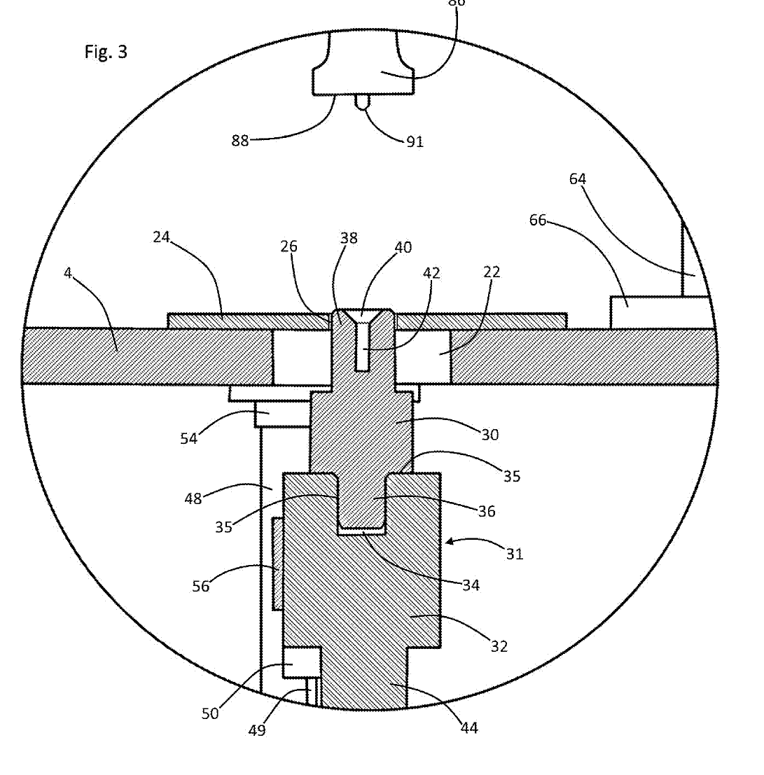

Referring in particular to FIG. 4, the gap 47 which is formed between the upper surface of stop 46 and the lower surface of plate 6 corresponds with and is representative of the length of the displacement of the contact member 31 from its first position (as depicted in FIGS. 2 and 3), to its second position (as depicted in FIGS. 4 and 5). The slide shaft 44, slide sleeve 18, slide stop 46, and biasing spring 16 combination depicted in FIG. 2 is intended as being representative of other commonly known mechanisms which are capable of normally moving and biasing an upper contact member such as contact member 31, and allowing travel of such member downwardly to an underlying second position.

Measuring means in the form of a linear encoder, referred to generally by Reference Arrow 51, are preferably provided. In a preferred embodiment, such encoder 51 has a vertical scale member 48 which is rigidly mounted to the frame 2 by means of upper and lower mounts 54 and 52. An electronic motion sensor unit 50 is mounted to the scale 48 for vertical upward and downward motions along a slide track or slot 49. A digital readout 60 is mounted to the frame 2 by a bracket 64, such readout 60 having a data cable 58 communicating with the sensor 50 and a power cored 62. The linear encoder 51 is preferably of the type which gauges positions along scale 51 in distance increments less than 1/1000″, and which is capable of reflecting any particular position of the sensor 50 along the scale 48 as being an assigned zero level. A tie arm 56 interconnects the contact member 31 with the sensor so that the sensor 50 and the contact member 31 precisely travel together.

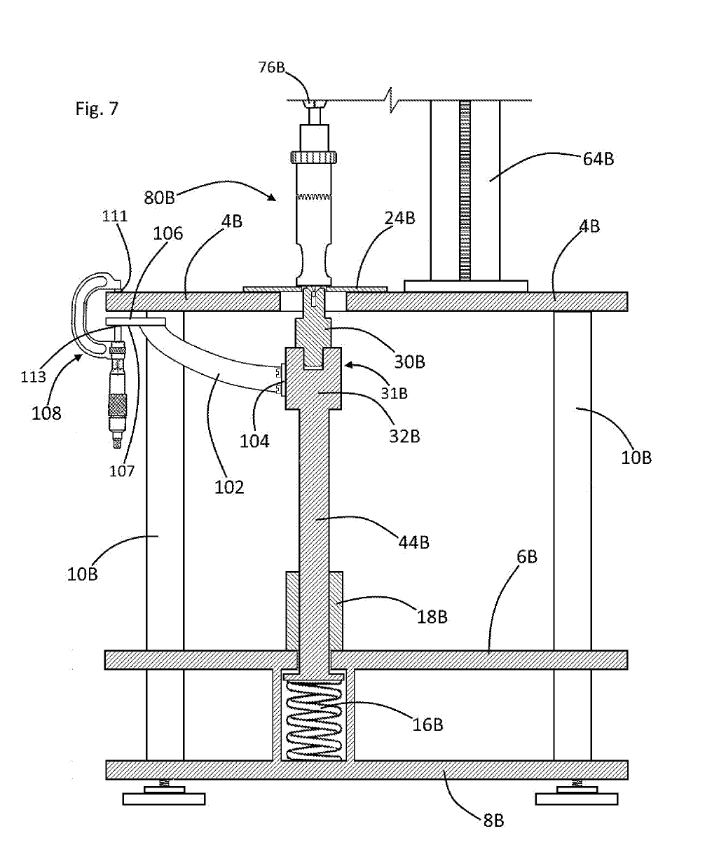

In an alternative measuring means represented in FIG. 7, all structures identified by reference numerals having the suffix “B” are configured substantially identically to similarly numbered structures appearing in FIGS. 1-5. In the FIG. 7 alternative, the contact member 31B is modified to include an extension arm 102 which is mounted via mounting plate 104. A flange 106 at the distal end of arm 102 presents a lower surface 107 which advantageously pairs with the upper surface of plate 4B for measured contacts between the jaws 111 an 113 of a calliper micrometer 108. The micrometer measuring means of FIG. 7 and the linear encoder measuring means of FIGS. 1, 2, 4, and 6 are intended as being representative of other commonly known precision measuring devices and assemblies which may measure and display the distance of the displacement of the contact member 31 between its first and second positions.

In use of the instant inventive assembly 1, a microstop 80 is selected by an operator for use as a master microstop. Such master microstop is preferably previously accurately set at a desired drilling depth. According to the function of the instant invention, such microstop is utilized as a representative of multiple other microstops which are similarly sized and configured, and which have substantially identical countersink or counterbore drilling bits.

Following selection of the master microstop 80, the operator may, referring in particular to FIGS. 8, 9, and 10, select a contact member upper half having an upwardly opening socket which is closely fitted for receiving and bearing against the cutting end of such microstop's bit. Thereafter, the operator may place the selected contact member upper half (contact member half 30 for example) upon the contact member lower half 32 so that the upper half's pin 36 nests within socket 34. In conjunction with the operator's selection of an installation of contact member upper half 30, the operator may select and install a plate 24 having an aperture 26 which is slightly greater than the outside diameter of the upper extension 38 of the contact member half 30.

Following screw attachment of the plate 24, the operator may mount and clamp the shank 92 of the microstop 80 within the jaws of chuck 76. Thereafter, the operator may turn crank handle 74 clockwise causing the sleeve 70, arm 78, chuck 76, and microstop 80 to move downwardly toward the contact member 31 until the lower platen 88 of the microstop 80 contacts the upper surface of plate 34. A continuation of such motion causes the lower cutting end of such microstop's cutting bit to travel within the casing 82,86 of the microstop 80 to the previously precisely gauged stopping point and extension limit.

Upon the bit's travel to its preset extension limit, the bit's cutting end 90,91, and the assembly's contact member 31 are downwardly positioned as depicted in FIG. 5. At such position, the assembly's linear encoder readout precisely reflects the vertical position of the contact member 31, and such position is preferably set in the linear encoder's microprocessor memory as being a zero level. Following such setting of the assembly's zero level, the master microstop 80 may be upwardly withdrawn, and may be disengaged from the chuck 76.

Thereafter, multiple other similarly configured microstops may be similarly engaged and manipulated within the assembly 2. Where downward bit extensions are reflected by the digital readout 60 as varying from the preestablished zero level, the extension of the microstop may be adjusted in 1/1000″ increments until the desired zero level is reached. Through use of the instant inventive microstop setting station, multiple microstops may be “zeroed out” to precisely match the extension set up of the master microstop, and such multiple microstops may be efficiently and conveniently configured for ongoing countersink drilling use.

While the principles of the invention have been made clear in the above illustrative embodiment, those skilled in the art may make modifications to the structure, arrangement, portions and components of the invention without departing from those principles. Accordingly, it is intended that the description and drawings be interpreted as illustrative and not in the limiting sense, and that the invention be given a scope commensurate with the appended claims.

The invention hereby claimed is:

1. An assembly for translating an extension of a first microstop countersink bit to second microstop countersink bit extensions, the first microstop having a shank, a first platen having a contact surface, and a bit having a cutting end alternatively extendable from and retractable toward said contact surface, said assembly comprising:
(a) a frame having a microstop end;
(b) a second platen having a contact surface, the second platen being supported at the frame's microstop end, the second platen having a port fitted for, upon a contact of the first platen's contact surface with the second platen's contact surface and upon the extension of the bit's cutting end from the first platen's contact surface, receiving the bit's cutting end;
(c) a contact member;
(d) means for positioning the contact member at a first position, said means being adapted for, upon the extension of the bit's cutting end from the first platen's contact surface, engaging the bit's cutting end at a contact point, said means being further adapted for permitting movement of the contact member toward a second position; and
(e) means for measuring a displacement of the contact member from the first position to the second position, said means being connected operatively to the contact member.

2. The assembly of claim 1 further comprising means for holding the first microstop, said means being adapted for moving the first microstop toward the contact member.

3. The assembly of claim 2 wherein the means for holding the first microstop comprises a chuck adapted for clamping the first microstop's shank.

4. The assembly of claim 3 wherein the means for holding the first microstop further comprise a guide bar.

5. The assembly of claim 4 wherein the means for holding the first microstop further comprise a linear motion actuator operatively spanning between the chuck and the guide bar.

6. The assembly of claim 1 wherein the contact member's contact point comprises a socket.

7. The assembly of claim 6 wherein the socket is closely fitted for receiving the cutting end of the first microstop's bit.

8. The assembly of claim 7 wherein the contact member has a contact half, an opposite half, and a seam between said halves, the contact member being adapted for alternatively holding the contact half upon the opposite half and permitting a disconnection of said halves.

9. The assembly of claim 8 wherein the contact member further comprises a plurality of second contact halves, and wherein the contact member is adapted for further alternatively holding one of the second contact halves upon the opposite half.

10. The assembly of claim 1 wherein the means for measuring a displacement of the contact member from the first position to the second position comprise a linear encoder.

11. The assembly of claim 10 wherein the linear encoder comprises a scale member and a sensor member, wherein one of said members is immovably mounted with respect to the frame and wherein the other of said members is immovably mounted with respect to the contact member.

12. The assembly of claim 11 wherein the linear encoder further comprises a digital readout.

13. The assembly of claim 12 wherein the linear encoder is adapted for assigning a zero level to the measurement of the displacement of the contact member from the first position to the second position, and for displaying different displacements of the contact member as distances from said assigned zero level.

14. The assembly of claim 1 further comprising biasing means connected operatively to the contact member, the biasing means being adapted for normally moving the contact member toward its first position.

15. The assembly of claim 14 wherein the biasing means comprise a spring, slide bar, and slide sleeve combination.

16. The assembly of claim 15 wherein the biasing means further comprise a slide stop connected operatively to the slide bar, the slide stop being adapted for resisting movement of the contact member at said member's first position.

17. The assembly of claim 1 wherein the second platen comprises a lower apertured plate and a first upper apertured plate.

18. The assembly of claim 17 wherein the second platen further comprises a second upper apertured plate, the second upper apertured plate's aperture being larger than that of the first upper apertured plate, the second upper apertured plate being interchangeable with the first upper apertured plate.
